(19) United States
(12) Patent Application Publication
(10) Pub. No.: US 2024/0182696 A1
(43) Pub. Date: Jun. 6, 2024

(54) DISPERSANT AND METHOD FOR MANUFACTURING THE SAME

(71) Applicant: SAMSUNG ELECTRO-MECHANICS CO., LTD., Suwon-si (KR)

(72) Inventors: Tae Min Kim, Suwon-si (KR); Geum Hee Yun, Suwon-si (KR); Hyun Gyoo Roh, Suwon-si (KR); Kyung Min Ok, Suwon-si (KR); Myung Hyun Jo, Suwon-si (KR); Ye Ri Yu, Suwon-si (KR)

(73) Assignee: SAMSUNG ELECTRO-MECHANICS CO., LTD., Suwon-si (KR)

(21) Appl. No.: 18/127,231

(22) Filed: Mar. 28, 2023

(30) Foreign Application Priority Data
Dec. 6, 2022 (KR) 10-2022-0168911

(51) Int. Cl. C08L 31/02; C08F 218/10

(52) U.S. Cl. CPC C08L 31/02; C08F 218/10; C08L 2203/20

(57) ABSTRACT

A dispersant according to an example embodiment of the present disclosure includes a polyvinyl acetal-based resin satisfying a degree of polymerization of 100 or more and 500 or less, a molecular weight of 10000 g/mol or more and 30000 g/mol or less, and an average diameter of 400 μm or more and 5500 μm or less.

### CROSS-REFERENCE TO RELATED APPLICATION (S)

This application claims benefit of priority to Korean Patent Application No. 10-2022-0168911 filed on Dec. 6, 2022, in the Korean Intellectual Property Office, the disclosure of which is incorporated herein by reference in its entirety.

### TECHNICAL FIELD

The present disclosure relates to a dispersant and a method for manufacturing the same.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

The multilayer ceramic capacitor may be used as a component of various electronic devices due to having a small size, ensuring high capacity and being easily mounted. With the miniaturization and high output power of various electronic devices such as computers and mobile devices, demand for miniaturization and high capacity of stacked ceramic capacitors has also been increasing.

Meanwhile, in the case of a fine dielectric powder for manufacturing small and high-capacity multilayer electronic components, an agglomeration phenomenon may easily occur due to electrostatic characteristics of a surface thereof. Since this may make it difficult to smoothly implement dielectric characteristics and generate non-uniformities such as dielectric characteristics of a product, a dispersant is added for dispersing the dielectric powder to solve such a problem. However, for the dispersant, unlike a binder, since it is considered to be less important, there is a lack of research into various factors affecting the dispersibility of the dispersant.

The sizes of the dispersants may also vary, and polyvinyl butyral (PVB) may be used for fine particles, but this may generate a significant amount of dust and thus lead directly to a safety problem for a worker in the long term. Accordingly, granules are more industrially utilized than fine particles, and for granules, a method of compressing powder mixtures and then crushing or assembling the powder mixtures to prepare a granular size is used.

### RELATED ART DOCUMENT

### Patent Document

(Patent Document 1) Korean Unexamined Patent Application Publication No. 10-2019-0121222

### SUMMARY

An aspect of the present disclosure is to provide a dispersant having a low degree of polymerization, an appropriate molecular weight, and a granular size, thereby minimizing operations in manufacturing process and reducing worker hazard during a powder operation.

However, the technical aspects of the present disclosure are not restricted to those set forth herein, and will be more easily understood in the process of describing specific embodiments of the present disclosure.

According to an aspect of the present disclosure, a dispersant includes a polyvinyl acetal-based resin satisfying a degree of polymerization of 100 or more and 500 or less, a molecular weight of 10000 g/mol or more and 30000 g/mol or less, and an average diameter of 400 or more and 5500 μm or less.

According to an aspect of the present disclosure, a method for manufacturing a dispersant includes preparing a first solution by dissolving polyvinyl alcohol in an organic solvent; preparing a second solution by adding an acidic solution to the first solution to induce a condensation reaction; preparing a third solution by adding aldehyde to the second solution; and precipitating a polyvinyl acetal-based resin by mixing the third solution with a water-soluble solvent, and the polyvinyl alcohol may satisfy a degree of polymerization of 100 or more and 500 or less and a molecular weight of 10000 g/mol or more and 30000 g/mol or less.

According to an aspect of the present disclosure, a method for manufacturing a dispersant includes preparing a first solution by dissolving polyvinyl alcohol in an organic solvent, wherein a content of the polyvinyl alcohol in the first solution satisfies 7 wt % or more and 13 wt % or less; and condensing the polyvinyl alcohol and an aldehyde to form a polyvinyl acetal-based resin.

One of the various effects of the present disclosure is to minimize operations of a producing process and reduce worker hazard by crushing powder into granules.

However, various and beneficial advantages and effects of this disclosure are not restricted to those set forth herein, and will be more easily understood in the process of describing specific embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a process view of a method for manufacturing a dispersant according to an example embodiment of the present disclosure;

FIG. 2 schematically illustrates a condensation reaction of a polyvinyl acetal;

FIG. 3 is a perspective view schematically illustrating a multilayer electronic component according to an example embodiment of the present disclosure;

FIG. 4 schematically illustrates an exploded perspective view illustrating a stacked structure of an inner electrode;

FIG. 5 is a schematic cross-sectional view taken along line I-I′ of FIG. 3; and

FIG. 6 is a schematic cross-sectional view taken along line II-II′ of FIG. 3.

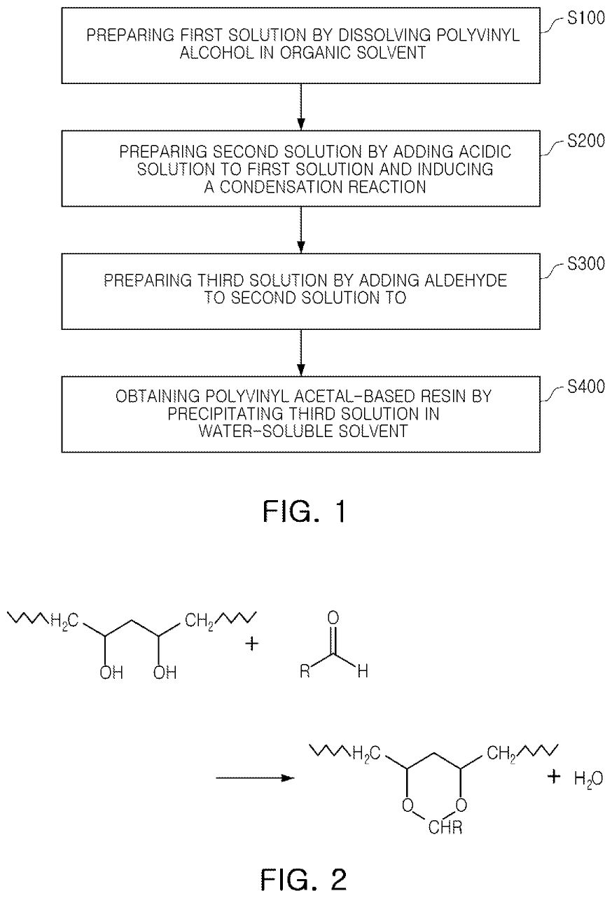

### DETAILED DESCRIPTION

Hereinafter, exemplary embodiments of the present disclosure will now be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the thicknesses of layers and regions are exaggerated for clarity. Like reference numerals in the drawings denote like elements, and thus their description will be omitted.

In addition, parts not associated with description are omitted for clearly describing the exemplary embodiments of the present disclosure, and since sizes and thicknesses of each component illustrated in the drawings are arbitrarily represented for convenience in explanation, the present disclosure is not particularly limited to the illustrated sizes and thicknesses of each component. Furthermore, components with the same functions within the scope of the same technical concept shown in the drawings of each embodiment will be described using the same reference numerals.

Throughout the specification, unless explicitly described to the contrary, the word “comprise” and variations such as “comprises” or “comprising” will be understood to imply the inclusion of stated elements but not the exclusion of any other elements.

In the drawings, a first direction may be defined as a stacking direction or a thickness T direction, a second direction may be defined as a length L direction, and a third direction may be defined as a width W direction.

### Dispersant

In the case of a fine dielectric powder for manufacturing small and high-capacity multilayer electronic components, an agglomeration phenomenon may easily occur due to electrostatic characteristics of a surface thereof. Since this may make it difficult to smoothly implement dielectric characteristics and generate non-uniformities such as dielectric characteristics of a product, a dispersant is added for dispersing the dielectric powder to solve such a problem.

However, unlike a binder, the dispersant is considered to be less important, and accordingly, there is a lack of research on various factors affecting the dispersibility of the dispersant.

This problem may be solved using a homogeneous reaction method among the synthesis methods of polyvinyl acetal. The homogeneous reaction is a non-aqueous reaction method, and unlike an aqueous reaction, since a non-aqueous reaction is a homogeneous reaction, it is easier to control a functional group than the aqueous reaction, and the homogeneous reaction can be acetalized, which may be suitable for a study on the dispersibility for each factor. However, the homogeneous reaction may be manufactured from polyvinyl acetal having a low degree of polymerization (DP) with a fine particle size, and since the polyvinyl acetal may cause an agglomeration phenomenon during powder collection due to a difference in polarity as compared to polyvinyl acetals having a high degree of polymerization (DP), it may be difficult to deal with during work and thus lead to non-uniformity of products. In addition, fine particles may cause a significant amount of dust during work, which may directly lead to safety problems for a worker in the long run. Here, the degree of polymerization (DP) may refer to the number of monomers bonded to one chain of polymer.

Accordingly, granules may be more industrially useful than fine particles. In the case of the granules, a method of compressing powder mixtures and then crushing or processing the same to form a granular size may be used, from which manufacturing into the granular size to be implemented may not be easily performed, and since the method further includes complex operations, process economics may be unsuitable.

However, in the case of the conventional polyvinyl acetal having a low degree of polymerization, only a fine particle size is used, and accordingly, the present disclosure aims to provide a polyvinyl acetal having a granular size while having a low degree of polymerization and an appropriate molecular weight, which solves the aforementioned problems.

A dispersant according to an example embodiment of the present disclosure may include polyvinyl acetal-based particles having a degree of polymerization of 100 or more and 500 or less, a molecular weight of 10000 g/mol or more and 30000 g/mol or less, and an average diameter of 400 μm or more and 5500 μm or less.

A low-polymerization dispersant with a degree of polymerization of 100 or more and 500 or less may not affect particle growth of the dielectric. By suppressing abnormal grain growth, it is possible to manufacture a uniform ceramic green sheet and a dielectric layer with a microstructure, thereby improving reliability of multilayer electronic components. In addition, the viscosity of a dielectric slurry can be adjusted by using the low-polymerization dispersant, thereby shortening a volatile operation time.

When the degree of polymerization is less than 100, dispersibility may be uniformly secured, but when a dielectric green sheet is formed of the dielectric slurry, a plasticization effect may be given, which may make it difficult to control extension. When the degree of polymerization is more than 500, dispersibility may be reduced to cause an agglomeration phenomenon, and compatibility with the binder may also be reduced to degrade surface roughness of the ceramic green sheet. The degree of polymerization of the polyvinyl acetal-based resin may be the same degree of polymerization of the polyvinyl alcohol used to prepare the polyvinyl acetal-based resin. The degree of polymerization of the polyvinyl alcohol is described further below.

The molecular weight may refer to a number average molecular weight, and in the case of a high molecular weight dispersant having a molecular weight of 10000 g/mol or more and 30000 g/mol or less, manufacture of a granular size may be easily performed, and the dispersant even with a low degree of polymerization may serve as a dispersant. The number average molecular weight of the polymers disclosed herein can be determined by gel permeation chromatography, viscometry, colligative methods, such as vapor pressure osmometry, end-group determination, and proton NMR. Other methods and/or tools appreciated by one of ordinary skill in the art, even if not described in the present disclosure, may also be used.

When the molecular weight is less than 10000 g/mol, dispersibility can be uniformly secured, but when a dielectric green sheet is formed of the dielectric slurry, a plasticization effect may be given, which may make it difficult to control extension. When the molecular weight is more than 30000 g/mol, dispersibility may be reduced to cause an agglomeration phenomenon, and compatibility with the binder may also be reduced to degrade surface roughness of the ceramic green sheet.

An average diameter of the polyvinyl acetal-based resin may be 400 μm or more and 5500 μm or less. The diameter disclosed herein may be obtained from the micrograph (s) of the dispersant. Other methods and/or tools appreciated by one of ordinary skill in the art, even if not described in the present disclosure, may also be used. The average diameter may be an average of 10, 20 or 30 diameters.

Polyvinyl acetal-based resin particles may have various shapes such as a circular polyvinyl acetal-based resin or an elliptical polyvinyl acetal-based resin.

Here, the circular polyvinyl acetal-based resin may include a shape that is not completely spherical, for example, a shape in which a length ratio (long axis/short axis) between a long axis and a short axis may be 1.45 or less.

In this case, the diameter of the circular polyvinyl acetal-based resin may be 500 μm or more and 4000 μm or less.

The elliptical polyvinyl acetal-based resin may refer to particles having a flat and elongated shape, and the present disclosure is not limited thereto, but for example, a length ratio (long axis/short axis) of the elliptical polyvinyl acetal-based resin between a long axis and a short axis may be 1.95 or more.

In this case, in the case of the elliptical polyvinyl acetal-based resin, a long axis size may be 500 μm or more and 7000 μm or less, and a short axis size may be 300 μm or more and 4000 μm or less.

When the size of the polyvinyl acetal-based resin satisfies the above-described range, the advantages of the granular size may be more effectively utilized, and when the size of the polyvinyl acetal-based resin is less than the above-described range, the polyvinyl acetal-based resin may have a fine particle size, which may cause the agglomeration phenomenon and safety problems during work. When the size of the polyvinyl acetal-based resin is more than the above-described range, it may be difficult to serve as a dispersant.

In an example embodiment of the present disclosure, the polyvinyl acetal-based resin may include polyvinyl butyral (PVB).

Referring to FIG. 2 schematically illustrating a condensation reaction of polyvinyl acetal, the polyvinyl butyral (PVB) may be manufactured by reacting polyvinyl alcohol (PVA) and butyraldehyde (BA) under a hydrochloric acid catalyst.

A polyvinyl butyral resin has a property of being easily dissolved in other organic solvents such as alcohol, ketone, and ester, and has good compatibility with other resins, for example, synthetic resins such as a phenol resin, a melamine resin, a urea resin, and an alkyd resin.

The polyvinyl butyral may serve as a dispersant for efficient dispersion of inorganic powder, and may also serve as a binder for imparting strength and adhesion to the ceramic green sheet.

For example, the inorganic powder may include metal particles, conductive particles, ceramic particles, dielectric particles, and glass powder.

In this case, the amount of hydroxyl groups of polyvinyl acetals may be 10 mol % or more and 60 mol % or less.

Since the amount of hydroxyl groups is satisfied with 10 mol % or more and 60 mol % or less, dispersibility may be excellent in the dielectric slurry composition, and fluidity and rigidity of the ceramic green sheet may be improved.

When the amount of hydroxyl groups is less than 10 mol %, the dielectric particles may be difficult to sufficiently disperse, which may cause the agglomeration phenomenon of the dielectric particles, provide insufficient dielectric sheet and strength, degrade thermal compressibility of the ceramic green sheet. When the amount of hydroxyl groups is more than 60 mol %, inorganic powder may be agglomerated, and the peelability and strength from a support of the ceramic green sheet may be degraded. The amount of hydroxyl groups of the polymers disclosed herein may be measured by titration methods. Other methods and/or tools appreciated by one of ordinary skill in the art, even if not described in the present disclosure, may also be used.

Although the dispersant according to an example embodiment of the present disclosure has been mainly described to be inserted into the dielectric slurry so as to improve the dispersibility of dielectric particles, the present disclosure is not particularly limited thereto, and the dispersant also be used as a dispersant of an internal electrode paste. When used as the dispersant of the internal electrode paste, the agglomeration of metal particles may be prevented and the dispersibility of the metal particles may be improved. That is, the dispersibility of the inorganic powder may be improved.

### Method for Manufacturing Dispersant

Hereinafter, a method of producing a dispersant will be described, and the same content as the above-described dispersant will be omitted.

A conventional method for manufacturing granules includes: an operation of dissolving polyvinyl alcohol; an operation of adding a catalyst and reactant; an operation of recovering polyvinyl butyral after completing the reaction; a drying operation after neutralization and washing; and an operation of obtaining granular polyvinyl butyral through a crushing operation after compressing fine polyvinyl butyral.

In the case of polyvinyl butyral having low polymerization with a degree of polymerization of 500 or less and having a high molecular weight of 10000 g/mol to 30000 g/mol, the polyvinyl butyral particles typically are fine and not of granular size. To manufacture the particles in a granular size, the particles having a fine size needs to be further subject to operations such as compression or crushing, which may result in an uneconomical part in the process.

According to an example embodiment of the present disclosure, a method for manufacturing a dispersant includes: preparing a first solution by dissolving polyvinyl alcohol in an organic solvent; preparing a second solution by adding an acidic solution to the first solution and inducing a condensation reaction; preparing a third solution by adding aldehyde to the second solution; and obtaining a polyvinyl acetal-based resin by precipitating the third solution in a water-soluble solvent, and the polyvinyl alcohol may satisfy a degree of polymerization of 100 or more and 500 or less and a molecular weight of 10000 g/mol or more and 30000 g/mol or less.

That is, according to the method for preparing a dispersant according to an example embodiment of the present disclosure, since polyvinyl acetal particles may be obtained in a granular size rather than a fine size, they do not need to be subject to a neutralization and washing operation and a compression and crushing operation. Accordingly, the method for preparing a dispersant may be economically effective.

A polyvinyl acetal-based resin obtained by the above-described method may have a degree of polymerization of 100 or more and 500 or less, a molecular weight of 10000 g/mol or more than 30000 g/mol or less, and an average diameter of 400 μm or more and 5500 μm or less.

More specifically, the polyvinyl acetal may be obtained by a condensation (acetalization) reaction between polyvinyl alcohol and aldehyde.

As another method for preparing the polyvinyl acetal, the polyvinyl acetal may be synthesized by simultaneously performing a saponification of the polyvinyl acetate and a condensation reaction of the aldehyde.

The polyvinyl acetal may have a variety of properties depending on the type of aldehyde to be bonded, the degree of acetalization, the amount of residual acetyl groups, the degree of polymerization of polyvinyl alcohol as a raw material, and the like. That is, the polyvinyl acetal may have various properties depending on the degree of polymerization or the molecular weight.

First, the operation of preparing the first solution by dissolving polyvinyl alcohol in the organic solvent may be performed.

The polyvinyl alcohol may have the degree of polymerization of 100 or more and 500 or less and the molecular weight of 10000 g/mol or more and 30000 g/mol or less.

According to the production method of the present disclosure, the degree of polymerization and the molecular weight of the polyvinyl alcohol, which is a raw material before the condensation reaction, do not significantly affect the degree of polymerization and the molecular weight of the obtained polyvinyl acetal, and the polyvinyl alcohol and the polyvinyl acetal may be obtained to have the same or similar characteristics.

Accordingly, the obtained polyvinyl acetal-based resin may also satisfy the degree of polymerization of 100 or more and 500 or less and the molecular weight of 10000 g/mol or more and 30000 g/mol or less. The degree of polymerization in the polyvinyl alcohol may be obtained by dividing the number-average molecular weight of the polyvinyl alcohol by the molecular weight of the repeating unit. Other methods and/or tools appreciated by one of ordinary skill in the art, even if not described in the present disclosure, may also be used.

The polyvinyl alcohol may be obtained by copolymerizing a vinyl ester with an ethylenically unsaturated monomer within a range of an amount that does not impair the effects of the present disclosure. The ethylenically unsaturated monomer is not particularly limited, and for example, may be acrylic acid, methacrylic acid, (anhydrous) phthalic acid, (anhydrous) maleic acid, (anhydrous) itaconic acid, acrylonitrile methacrylonitrile, acrylamide, methacryl amide, trimethyl-(3-acrylamide-3-dimethylpropyl)-ammonium chloride, acrylamide-2-methylpropane sulfonic acid and a sodium salt thereof; ethyl vinyl ether, butyl vinyl ether, N-vinyl pyrrolidone, vinyl chloride, vinyl bromide, vinyl fluoride, vinylidene chloride, vinylidene fluoride, tetrafluoroethylene, sodium vinyl sulfonate, sodium aryl sulfonate, and the like. In addition, terminal modified polyvinyl alcohol obtained by copolymerizing a vinyl ester monomer, such as vinyl acetate, and ethylene and saponifying the same in the presence of thiol compounds such thiol as acetic acid and mercaptopropionic acid may be used.

The polyvinyl alcohol may be obtained by saponifying a copolymer obtained by copolymerizing the vinyl ester and α-olefin. The polyvinyl alcohol may further copolymerize with the ethylenically unsaturated monomer and contain a component derived from the ethylenically unsaturated monomer. In addition, terminal polyvinyl alcohol obtained by copolymerizing a vinyl ester monomer such as vinyl acetate and the α-olefin and saponifying the same in the presence of thiol compounds such as thiol acetic acid and mercaptopropionic acid. The α-olefin is not particularly limited, and may include, for example, methylene, ethylene, propylene, isopropylene, butylene, isobutylene, pentylene, hexylene, cyclohexylene, cyclohexyl ethylene, cyclohexyl propylene, and the like.

N-methylpyrrolidone (NMP) may be used as an organic solvent, but the organic solvent is not particularly limited thereto, and for example, ketones such as acetone, methyl ethyl ketone, dipropyl ketone, diisobutyl ketone, etc., alcohols such as methanol, ethanol, isopropanol, butanol, etc., aromatic hydrocarbons such as toluene, xylene, etc., esters such as methyl propionate, ethyl propionate, butyl propionate, methyl butane, ethyl butane, butyl butyrate, methyl pentate, ethyl pentate, butyl pentanate, methyl hexane, ethyl hexane, butyl hexane, 2-ethylhexyl acetate, 2-ethylhexyl butyrate, etc., and terpineols such as terpineol, dihydrotherpineol, terpineol acetate, dihydrotherpineol acetate, and derivatives thereof. These organic solvents may be used alone or in combination of two or more types thereof.

The degree of saponification of the polyvinyl alcohol may be preferably 95% or more, and more preferably 99% or more. A molecular weight thereof may be 10000 g/mol or more and 30000 g/mol or less. When dissolving the polyvinyl alcohol in an organic solvent, the polyvinyl alcohol may preferably be dissolved at a temperature of 100° ° C. to 150° C., and may more preferably be maintained at a temperature of 120° C. The dissolution time is preferably 30 minutes to 2 hours, and more preferably, the first solution is stirred and dissolved for 1 hour.

In this case, the content of polyvinyl alcohol in the first solution may satisfy 7 wt % or more and 13 wt % or less.

Here, the first solution may refer to a solution including both polyvinyl alcohol and an organic solvent, and more specifically, the first solution may denote that the content of {(polyvinyl alcohol)/(polyvinyl alcohol+organic solvent)}×100 (wt %) satisfies 7 wt % or more and 13 wt % or less.

As the content of polyvinyl alcohol in the first solution satisfies 7 wt % or more and 13 wt % or less, polyvinyl acetal having a degree of polymerization of 500 or less, a molecular weight of 10000 g/mol or more and 30000 g/mol or less, and a granular size may be obtained.

When the content of polyvinyl alcohol in the first solution is less than 7 wt %, the polyvinyl acetal may be agglomerated, and when the content of polyvinyl alcohol in the first solution is more than 13 wt %, it may difficult to obtain the dispersant by hardening the solution.

Next, the operation of preparing the second solution by adding an acidic solution to the first solution and inducing a condensation reaction may be performed.

As a catalyst for the condensation reaction, an inorganic material such as hydrochloric acid or sulfuric acid may be used, and acetalization of polyvinyl alcohol may be provided by adding an acidic solution.

In this case, the concentration of hydrochloric acid may be preferably 30% or more and 40% or less, and more preferably 35%. For hydrochloric acid, since there is a risk that heat may occur, the hydrochloric acid may be dissolved while maintaining a relatively low temperature of 40° C. or less, more preferably 30° C.

Next, the operation of preparing the third solution by adding aldehyde to the second solution may be performed.

The aldehyde is a compound in which a formyl group is added to a hydrocarbon group, and a molecular formula thereof may be represented by R—CHO. As the aldehyde, formaldehyde and butyl aldehyde may be used, which may become polyvinyl formal (PVF) and polyvinyl butyral (PVB) by condensation reactions, respectively. That is, the polyvinyl formal and the polyvinyl butyral correspond to polyvinyl acetals.

However, the present disclosure is not limited thereto, and for example, acetaldehyde, propionaldehyde, and benzaldehyde may be used as the aldehyde, and for example, acetone, methyl ethyl ketone, hexanone, and cyclohexanone may be used as ketones.

When the aldehyde is added and stirred, the aldehyde may be added relatively slowly, and when an excessive amount of the aldehyde is added, work safety may be problematic. In addition, a constant temperature may be maintained when adding and stirring the aldehyde, and the polymer be kept soluble throughout the process.

Next, the operation of obtaining the polyvinyl acetal-based resin by precipitating the third solution in the water-soluble solvent may be performed.

Here, sodium hydroxide may be added to a material generated after 2 to 72 hours of the formation of the third solution, thereby obtaining the polyvinyl acetal-based resin in a granular size.

The water-soluble solvent may be water, but the present disclosure is not particularly limited thereto, and any material having a water-soluble group may be used.

Here, when the sodium hydroxide is added, a polyvinyl acetal resin may be more easily obtained. The sodium hydroxide may be added in an amount of 0.1 g or more and 5.0 g or less with respect to 1 L of the water-soluble solvent.

Next, the obtained polyvinyl acetal-based resin may be washed with water and dried in a vacuum, thereby obtaining a particle or powder-type polyvinyl acetal-based resin having an average diameter of 400 μm or more and 5500 μm or less.

Hereinafter, the present disclosure will be described in more detail through embodiments, but these are meant to aid a detailed understanding of the present disclosure and the scope of the present disclosure is not limited by the embodiments.

### Embodiment

Table 1 below describes whether granule-sized polyvinyl butyral is obtained according to Examples and Comparative Examples.

PVA refers to polyvinyl alcohol, and DP refers to a degree of polymerization, and when the average diameter of the obtained polyvinyl butyral (PVB) satisfies 400 μm or more and 5500 μm or less, the PVB was evaluated as a granular size and described as “O”, and when the average diameter does not satisfy or meet the range, it was described as “X”.

In Example 1, 11.5 g of the PVA (a saponification degree of 99%) having a DP of 300 and a molecular weight of 13000 g/mol was dissolved in 100 mL of N-methylpyrrolidone (NMP) at 120° C. for 1 hour. Then, a prescribed amount of hydrochloric acid (35%) was added to catalyze condensation. A certain amount of butyraldehyde (BA) was slowly added while stirring at 30° C. The mixture was maintained at a prescribed temperature while stirring the mixture, and the polymer was kept soluble throughout the process. A product produced after a certain period of time (between 2 and 72 hours) was slowly precipitated in 900 mL of water containing 0.45 g of sodium hydroxide to obtain the PVB. After the PVB was washed several times, the PVB was finally dried in vacuum.

In Example 2, 11.5 g of the PVA (a saponification degree of 99%) having a DP of 500 and a molecular weight of 22000 g/mol was used, and other conditions and the producing method were the same as in Example 1.

In Comparative Example 1, 11.5 g of the PVA (a saponification degree of 99%) having a DP of 300 and a molecular weight of 13000 g/mol was used and dissolved in 550 mL of NMP. Other conditions and thea producing method are the same as in Example 1.

In Comparative Example 2, 11.5 g of the PVA (a saponification degree of 99%) having a DP of 300 and a molecular weight of 13000 g/mol was used and dissolved in 218 mL of NMP. Other conditions and a producing method are the same as in Example 1.

In Comparative Example 3, 11.5 g of the PVA (a saponification degree of 99%) having a DP of 300 and a molecular weight of 13000 g/mol was used and dissolved in 65 mL of NMP. Other conditions and a producing method are the same as in Example 1.

In Comparative Example 4, 11.5 g of the PVA (a saponification degree of 99%) having a DP of 600 and a molecular weight of 27000 g/mol was used and dissolved in 550 mL of NMP. Other conditions and a producing method are the same as in Example 1.

TABLE 1

| Test Examples | DP of PVA | Solvent (mL) | Granulation Status |
|---|---|---|---|
| Example 1 | 300 | 100 | ◯ |
| Example 2 | 500 | 100 | ◯ |
| Comparative | 300 | 550 | X |
| Example 1 | | | |
| Comparative | 300 | 218 | X |
| Example 2 | | | |
| Comparative | 300 | 65 | X |
| Example 3 | | | |
| Comparative | 600 | 550 | X |
| Example 4 | | | |

Embodiments 1 and 2 showed that granular PVB was formed, but Comparative Examples 1 and 2 showed that the PVB was agglomerated, Comparative Example 3 showed that the PVB in the form of particles due to the high viscosity of the PVA solution (e.g., the solution hardened), and Comparative Example 4 showed that the PVB was obtained as particles with a fine particle size even though the degree of polymerization was 600.

According to the method for preparing the dispersant according to an example embodiment of the present disclosure, the PVB particles having a degree of polymerization degree of 100 or more and 500 or less, a molecular weight of 10000 g/mol or more and 30000 g/mol or less, and an average diameter of 400 μm or more and 5500 μm or less may be obtained, a process operation may be simplified, and a granular dispersant may be used, thereby achieving simplification of factory work and stability of workers.

### Multilayer Electronic Component

Hereinafter, a multilayer electronic component including a dielectric layer formed by inserting the above-described dispersant into a dielectric slurry, or including an internal electrode formed by inserting the above-described dispersant into an internal electrode paste

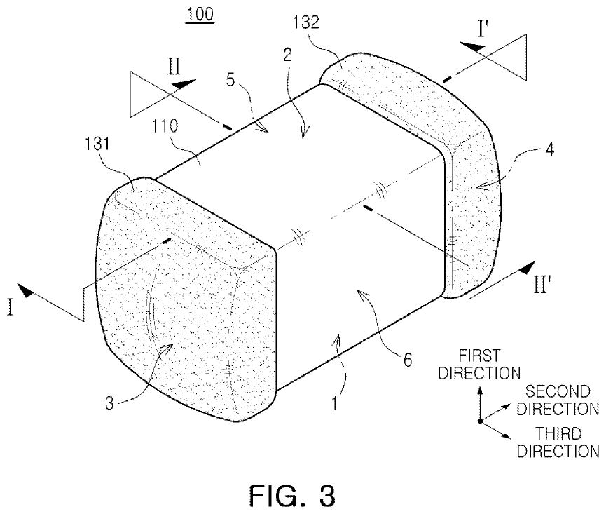

FIG. 3 is a perspective view schematically illustrating a multilayer electronic component according to an example embodiment of the present disclosure.

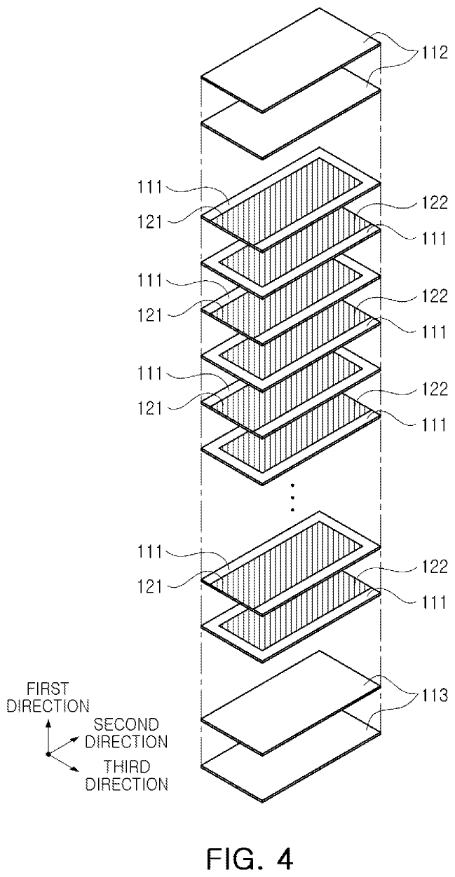

FIG. 4 schematically illustrates an exploded perspective view illustrating a stacked structure of an inner electrode.

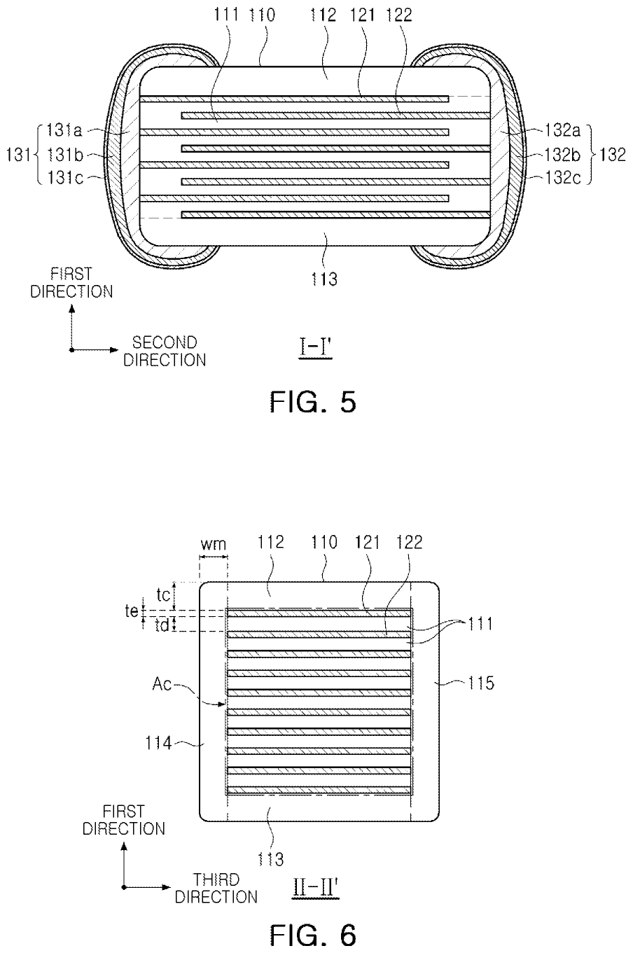

FIG. 5 is a schematic cross-sectional view taken along line I-I′ of FIG. 3.

FIG. 6 is a schematic cross-sectional view taken along line II-II′ of FIG. 3.

Hereinafter, a multilayer electronic component according to an example embodiment of the present disclosure will be described in detail with reference to FIGS. 3 to 6. However, although a multilayer ceramic capacitor is described as an example of the multilayer electronic component, the present disclosure may be applied to various electronic products using a dielectric composition, for example, an inductor, a piezoelectric device, a varistor, or a thermistor.

In a body 110, a dielectric layer 111 and internal electrodes 121 and 122 are alternately stacked.

More specifically, the body 110 may include a capacity forming portion Ac that is disposed inside the body 110 by including first and second internal electrodes 121 and 122 disposed in the body 110 and alternately disposed to face each other with the dielectric layer 111 interposed therebetween.

There is no particular limitation on the specific shape of the body 110, but as illustrated, the body 110 may have a hexahedral shape or a similar shape thereof. Due to contraction of the ceramic powder including in the body 110 during a firing process, the body 110 may not have a hexahedral shape with a complete straight line, but may have a substantially hexahedral shape.

The body 110 may have first and second surfaces 1 and 2 facing each other in the first direction, third and fourth surfaces 3 and 4 connected to the first and second surfaces 1 and 2 and facing each other in the second direction, and fifth and sixth surfaces 5 and 6 connected to the first, second, third and fourth surfaces 1, 2, 3 and 4 and facing each other in the third direction.

In a state in which a plurality of dielectric layers 111 forming the body 110 are sintered, boundaries between adjacent dielectric layers 111 may be so integrated so as to be difficult to identify without using a scanning electron microscope (SEM).

A material forming the dielectric layer 111 is not limited as long as it may obtain sufficient capacitance. In general, a perovskite (ABO₃)-based material may be used, for example, a barium titanate-based material, a lead composite perovskite-based material, or a strontium titanate-based material may be used. An example of ceramic powder may include (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) in which Ca (calcium) and Zr (zirconium) are partially included in BaTiO₃ and BaTiO₃.

In addition, as raw materials forming the dielectric layer 111, various ceramic additives, organic solvents, binders, dispersants, and the like may be added to powders such as barium titanate (BaTiO₃), depending on the purpose of the present disclosure.

Here, the dispersant may include the dispersant prepared by the above-described producing method, and a dispersant having a low degree of polymerization, a high molecular weight, and a granular size may be used.

A thickness td of the dielectric layer 111 does not need to be particularly limited.

However, in order to achieve high capacity of the multilayer electronic component, the thickness of the dielectric layer 111 may be 3.0 μm or less, and in order to more easily achieve miniaturization and high capacity of the multilayer electronic component, the thickness of the dielectric layer 111 may be 1.0 μm or less, preferably 0.6 μm or less, and more preferably 0.4 μm or less.

Here, the thickness td of the dielectric layer 111 may denote a thickness td of the dielectric layer 111 disposed between the first and second internal electrodes 121 and 122.

Meanwhile, the thickness td of the dielectric layer 111 may denote a size of the dielectric layer 111 in the first direction. In addition, the thickness td of the dielectric layer 111 may denote an average thickness td of the dielectric layer 111 and may denote an average size of the dielectric layer 111 in the first direction.

The average size of the dielectric layer 111 in the first direction may be measured by scanning an image of first and second directional cross-sections of the body 110 with a scanning electron microscope (SEM) of 10,000× magnification. More specifically, the average size may be an average value obtained by measuring the size in the first direction at 30 areas which are spaced from each other at equal intervals in the second direction in one dielectric layer 111 on the scanned images. The 30 areas with the equal intervals may be designated in the capacity forming portion. In addition, when the average value is measured by extending an average value measurement up to 10 dielectric layers 111, the average size of the dielectric layers 111 in the first direction may be further generalized. Other methods and/or tools appreciated by one of ordinary skill in the art, even if not described in the present disclosure, may also be used.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately disposed to face each other with the dielectric layer 111 constituting the body 110 interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and be connected to the first internal electrode 121, and a second external electrode 132 may be disposed on the fourth surface 4 of the body 110 and be connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by a dielectric layer 111 disposed therebetween.

Meanwhile, the body 110 may be formed by alternately stacking a ceramic green sheet on which the first internal electrode 121 is printed and a ceramic green sheet on which the second internal electrode 122 is printed, and then sintering the ceramic green sheets.

A material forming the internal electrodes 121 and 122 is not particularly limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes including at least one of nickel (Ni), copper (Cu), palladium (Pd), silver (Ag), gold (Au), platinum (Pt), tin (Sn), tungsten (W), titanium (Ti), and alloys thereof on a ceramic green sheet. A method of printing the conductive paste for internal electrodes may include a screen printing method or a gravure printing method, and the present disclosure is not limited thereto.

Various ceramic additives, organic solvents, binders, dispersants, and the like may be added to metal particles such as conductive particles as a raw material for forming the internal electrodes 121 and 122, depending on the purpose of the present disclosure.

Here, the dispersants may include a dispersant manufactured by the above-described manufacturing method, and a dispersant having a low degree of polymerization, high molecular weight, and granular size may be used.

Meanwhile, a thickness te of the internal electrodes 121 and 122 does not need to be particularly limited.

However, in order to achieve high capacity of the multilayer electronic components, the thickness of the internal electrodes 121 and 122 may be 1.0 μm or less, and in order to easily achieve miniaturization and high capacity of the multilayer electronic components, the thickness of the internal electrodes 121 and 122 may be 0.6 μm or less, and more desirably 0.4 μm or less.

Here, the thickness te of the internal electrodes 121 and 122 may refer to the size of the internal electrodes 121 and 122 in the first direction. In addition, the thickness te of the internal electrodes 121 and 122 may refer to an average thickness te of the internal electrodes 121 and 122 and may refer to an average size of the internal electrodes 121 and 122 in the first direction.

The average size of the internal electrodes 121 and 122 in the first direction may be measured by scanning an image of the first and second directional cross-sections of the body 110 with a scanning electron microscope (SEM) of 10,000× magnification. More specifically, the average size may be an average value obtained by measuring the size in the first direction at 30 areas which are spaced from each other at equal intervals in the second direction in one internal electrode 121 or 122 on the scanned images. The 30 areas with the equal intervals may be designated in the capacity forming portion Ac. In addition, when the average value is measured by expanding an average value measurement up to 10 internal electrodes 121 and 122, the average size of the internal electrodes 121 and 122 in the first direction may be further generalized. Other methods and/or tools appreciated by one of ordinary skill in the art, even if not described in the present disclosure, may also be used.

Meanwhile, in one embodiment of the present disclosure, the thickness td of the dielectric layer 111 and the thickness te of the internal electrodes 121 and 122 may satisfy td>2×te.

In other words, the thickness td of the dielectric layer 111 may be greater than twice the thickness te of the internal electrodes 121 and 122.

In general, high-voltage electrical components may have reliability problems due to a decrease in the breakdown voltage (BDV) under a high-voltage environment.

Accordingly, in order to prevent the BDV from decreasing under the high-voltage environment, the thickness td of the dielectric layer 111 is greater than twice the thickness te of the internal electrodes 121 and 122, thereby increasing the thickness of the dielectric layer, which is a distance between the internal electrodes, and improving characteristics of the BDV.

When the thickness td of the dielectric layer 111 is less than or equal to twice the thickness te of the internal electrodes 121 and 122, since the dielectric layer, which is a distance between the internal electrodes, may be thin, the BDV may be decreased.

In the high-voltage electronic component, the thickness te of the internal electrode may be 1 μm or less, and the thickness td of the dielectric layer may be 3.0 μm or less, but the present disclosure is not limited thereto.

Meanwhile, the body 110 may include cover portions 112 and 113 disposed on opposite end-surface surfaces of the capacity forming portion Ac in the first direction.

More specifically, the body 110 may include an upper cover portion 112 disposed above the capacity forming portion Ac in the first direction and a lower cover portion 113 disposed below the capacity forming portion Ac in the first direction.

The upper cover portion 112 and the lower cover portion 113 may be formed by stacking a single dielectric layer 111 or two or more dielectric layers 111 on upper and lower surfaces of the capacity forming portion Ac in the first directions, and may basically serve to prevent damage to the internal electrodes 121 and 122 due to physical or chemical stress.

The upper cover portion 112 and the lower cover portion 113 do not include the internal electrodes 121 and 122 and may include the same material as the dielectric layer 111. That is, the upper cover portion 112 and the lower cover portion 113 may include a ceramic material, for example, a barium titanate (BaTiO₃)-based ceramic material.

Meanwhile, a thickness tc of the cover portions 112 and 113 does not need to be particularly limited.

However, in order to more easily achieve miniaturization and high capacity of the multilayer electronic components, the thickness tc of the cover portions 112 and 113 may be 100 μm or less, preferably 30 μm or less, and more preferably 20 μm or less in ultra-small products.

Here, the thickness tc of the cover portions 112 and 113 may denote the size of the cover portions 112 and 113 in the first direction. In addition, the thickness tc of the cover portions 112 and 113 may denote an average thickness tc of the cover portions 112 and 113 and may denote an average size of the cover portions 112 and 113 in the first direction.

The average size of the cover portions 112 and 113 in the first direction may be measured by scanning an image of the first and second directional cross-sections of the body 110 with a scanning electron microscope (SEM) of 10,000× magnification. More specifically, the average size may be an average value obtained by measuring the thickness at 30 areas which are spaced apart from each other at equal intervals in the second direction in one cover portion on the scanned image. Other methods and/or tools appreciated by one of ordinary skill in the art, even if not described in the present disclosure, may also be used.

Meanwhile, a multilayer electronic component 100 may include side margin portions 114 and 115 disposed on opposite end-surface surfaces of the body 110 in the third direction.

More specifically, the side margin portions 114 and 115 may include a first side margin portion 114 disposed on the fifth surface 5 of the body 110 and a second side margin portion 115 disposed on the sixth surface 6 of the body 110.

As illustrated, the side margin portions 114 and 115 may refer to a region between opposite end-surfaces of the first and second internal electrodes 121 and 122 in the third direction and a boundary surface of the body 110 with respect to the cross-sections of the body 110 in the first and third directions.

The side margin portions 114 and 115 form the internal electrodes 121 and 122 by applying a conductive paste on the ceramic green sheet applied to the capacity forming portion Ac, except for an area where the side margin portions 114 and 115 are formed, and in order to suppress a step portion of the internal electrodes 121 and 122, after the stacked internal electrodes 121 and 122 are cut to be exposed to the fifth and sixth surfaces 5 and 6 of the body 110, a single dielectric layer 111 or two or more dielectric layers 111 may be stacked and formed in the third direction on opposite end-surface surfaces of the capacity forming portion Ac in the third direction.

The side margin portion 114 and 115 may basically serve to prevent damage to the internal electrodes 121 and 122 due to physical or chemical stress.

The first side margin portion 114 and the second side margin portion 115 do not include the internal electrodes 121 and 122 and may include the same material as the dielectric layer 111. That is, the first side margin portion 114 and the second side margin portion 115 may include a ceramic material, for example, a barium titanate (BaTiO₃)-based ceramic material.

Meanwhile, a width wm of the first and second side margin portions 114 and 115 does not need to be particularly limited.

However, in order to more easily achieve miniaturization and high capacity of the multilayer electronic component 100, the width wm of the side margin portions 114 and 115 may be 100 μm or less, preferably 30 μm or less, and more preferably 20 μm or less in ultra-small products.

Here, the width wm of the side margin portions 114 and 115 may denote a size of the side margin portions 114 and 115 in the third direction. In addition, the width wm of the side margin portions 114 and 115 may denote an average width wm of the side margin portions 114 and 115, and may mean an average size of the side margin portions 114 and 115 in the third direction.

The average size of the side margin portions 114 and 115 in the third direction may be measured by scanning an image of the first and third directional cross-sections of the body 110 with a scanning electron microscope (SEM) of 10,000× magnification. More specifically, the average size may be an average value obtained by measuring the size in the third direction at 30 areas which are spaced apart from each other at equal intervals in the first direction on the scanned image. Other methods and/or tools appreciated by one of ordinary skill in the art, even if not described in the present disclosure, may also be used.

Although an example embodiment of the present disclosure describes a structure in which the ceramic electronic component 100 has two external electrodes 131 and 132, the number or shape of the external electrodes 131 and 132 may be changed according to the shape of the internal electrodes 121 and 122 or other purposes.

The external electrodes 131 and 132 may be disposed on the body 110 and may be connected to the internal electrodes 121 and 122.

More specifically, the external electrodes 131 and 132 may include first and second external electrodes 131 and 132 disposed on the third and fourth surfaces 3 and 4 of the body 110 and connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and be connected to the second internal electrode 122.

Meanwhile, the external electrodes 131 and 132 may be formed of any material as long as they have electrical conductivity like metal, and a specific material may be determined in consideration of electrical characteristics, structural stability, and the like, and may also have a multilayer structure.

For example, the external electrodes 131 and 132 may include electrode layers 131a, 132a, 131b and 132b disposed on the body 110 and plating layers 131c and 132c disposed on the electrode layers 131a, 132a, 131b and 132b.

For more specific examples of the electrode layers 131a, 132a, 131b and 132b, the electrode layers 131a, 132a, 131b and 132b may be a sintered electrode including a conductive metal and glass or a resin-based electrode including a conductive metal and a resin.

In addition, the electrode layers 131a, 132a, 131b and 132b may have a form in which the sintered electrode and the resin-based electrode are sequentially formed on a body.

In addition, the electrode layers 131a, 132a, 131b and 132b may be formed by transferring a sheet including a conductive metal onto the body or transferring the sheet including the conductive metal onto the sintered electrode.

A material having excellent electrical conductivity may be used as a conductive metal included in the electrode layers 131a, 132a, 131b and 132b. For example, the conductive metal may be at least one selected from the group consisting of nickel (Ni), copper (Cu), palladium (Pd), silver (Ag), gold (Au), platinum (Pt), tin (Sn), tungsten (W), titanium (Ti), and alloys thereof, but the present disclosure is not particularly limited thereto.

In an example embodiment of the present disclosure, the electrode layers 131a, 132a, 131b and 132b may have a two-layer structure including the first electrode layers 131a and 132a and the second electrode layers 131b and 132b. Accordingly, the external electrodes 131 and 132 may include first electrode layers 131a and 132a including conductive metals and glass, and second electrode layers 131b and 132b disposed on the first electrode layers 131a and 132a and including conductive metals and resins.

As the first electrode layers 131a and 132a include glass, they may serve to improve adhesion to the body 110, and as the second electrode layers 131b and 132b include a resin, they may server to improve bending strength.

The conductive metal used in the first electrode layers 131a and 132a is not particularly limited as long as it may be electrically connected to the internal electrodes 121 and 122 to form capacitance, and for example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof. The first electrode layers 131a and 132a may be formed by applying a conductive paste prepared by adding a glass frit to the conductive metal powder and then firing the conductive paste.

The conductive metal included in the second electrode layers 131b and 132b may serve to be electrically connected to the first electrode layers 131a and 132a.

The conductive metal included in the second electrode layers 131b and 132b is not particularly limited as long as it is a material electrically connected to the electrode layers 131a and 132a, and the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof.

The conductive metal included in the second electrode layers 131b and 132b may include at least one of spherical particles and flake-type particles. That is, the conductive metal may be formed of only flake-type particles, or may be formed of only spherical particles, or may be a mixture of flake-type particles and spherical particles. Here, the spherical particles can include a shape that is not completely spherical, for example, a shape in which a length ratio (long axis/short axis) between the long axis and the short axis is 1.45 or less. The flake-type particles refer to particles having flat and elongated shapes and the present disclosure is not particularly limited thereto, but for example, the length ratio (long axis/short axis) between a long axis and a short axis may be 1.95 or more. The lengths of the long axis and the short axis of the spherical particles and the flake-type particles may be measured from images obtained by scanning first and second directional cross-sections cut from a central portion of the ceramic electronic component in the third direction with the scanning electron microscope (SEM). Other methods and/or tools appreciated by one of ordinary skill in the art, even if not described in the present disclosure, may also be used.

A resin included in the second electrode layers 131b and 132b serves to secure adhesion and absorb impact. The resin included in the second electrode layers 131b and 132b has adhesion and shock absorption and is not particularly limited as long as the resin may be mixed with conductive metal powder to form a paste, and the resin may include, for example, an epoxy-based resin.

In addition, the second electrode layers and 132b may include a plurality of metal particles, an intermetallic compound, and a resin. As the intermetallic compound is included therein, the second electrode layers 131b and 132b may further improve electrical connectivity with the first electrode layers 131a and 132a. The intermetallic compound may serve to improve electrical connectivity by connecting a plurality of metal particles, and may surround the plurality of metal particles and connect the plurality of metal particles to each other.

In this case, the intermetallic compound may include a metal having a melting point lower than a curing temperature of the resin. That is, since the intermetallic compound contains the metal having the melting point lower than the curing temperature of the resin, the metal having the melting point lower than the curing temperature of the resin is melted during the drying and curing process, and surround the metal particles by forming the intermetallic compound with a portion of the metal particles. In this case, the intermetallic compound may include metal having a low melting point of 300° C. or less.

For example, the intermetallic compound may include Sn having a melting point of 213 to 220° C. During the drying and curing processes, Sn is melted, and metal particles at a high melting point, such as Ag, Ni, or Cu, are wetted in the melted Sn by a capillary phenomenon, and the melted Sn reacts with some of Ag, Ni, or Cu metal particles to form intermetallic compounds such as Ag₃Sn, Ni₃Sn₄, Cu₆Sn₅, and Cu₃Sn. The other Ag, Ni, or Cu metal particles that did not react therewith remain in the form of metal particles.

Accordingly, the plurality of metal particles may include one or more of Ag, Ni, and Cu, and the intermetallic compound may include one or more of Ag₃Sn, Ni₃Sn₄, Cu₆Sn₅, and Cu₃Sn.

The plating layers 131c and 132c serve to improve mounting characteristics.

A type of the plating layers 131c and 132c is not particularly limited, and may be a single layer of plating layers 131c and 132c including at least one of nickel (Ni), tin (Sn), palladium (Pd), and alloys thereof, and may be formed of a plurality of layers.

For more specific example, the plating layers 131c and 132c may be Ni plating layers or Sn plating layers, and may have a form in which the Ni plating layer and the Sn plating layer may be sequentially formed on the electrode layers 131a, 132a, 131b and 132b, and a form in which the Sn plating layer, the Ni plating layer and the Sn plating layer may be sequentially formed thereon. In addition, the plating layers 131c and 132c may include a plurality of Ni plating layers and/or a plurality of Sn plating layers.

Although the embodiment of the present disclosure has been described in detail above, the present disclosure is not limited to the above-described embodiments and the accompanying drawings but is defined by the appended claims.

Therefore, those of ordinary skill in the art may make various replacements, modifications, or changes without departing from the scope of the present invention defined by the appended claims, and these replacements, modifications, or changes should be construed as being included in the scope of the present invention.

In addition, the expression ‘one embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A dispersant comprising a polyvinyl acetal-based resin satisfying a degree of polymerization of 100 or more and 500 or less, a molecular weight of 10000 g/mol or more and 30000 g/mol or less, and an average diameter of 400 μm or more and 5500 μm or less.

2. The dispersant according to claim 1, wherein the polyvinyl acetal-based resin includes a circular polyvinyl acetal-based resin, and the circular polyvinyl acetal resin satisfies a diameter of 500 μm or more and 4000 μm or less.

3. The dispersant according to claim 1, wherein the polyvinyl acetal-based resin includes an elliptical polyvinyl acetal-based resin, and the elliptical polyvinyl acetal-based resin satisfies a long axis size of 500 μm or more and 7000 μm or less and a short axis size of 300 μm or more and 4000 μm or less.

4. The dispersant according to claim 1, wherein the polyvinyl acetal-based resin is a polyvinyl butyral resin.

5. The dispersant according to claim 1, wherein an amount of hydroxyl groups of the polyvinyl acetal-based resin satisfies 10 mol % or more and 60 mol % or less.

6. A method for manufacturing a dispersant, the method comprising:
preparing a first solution by dissolving polyvinyl alcohol in an organic solvent;
preparing a second solution by adding an acidic solution to the first solution to induce a condensation reaction;
preparing a third solution by adding aldehyde to the second solution; and
precipitating a polyvinyl acetal-based resin by mixing the third solution with a water-soluble solvent,
wherein the polyvinyl alcohol satisfies a degree of polymerization of 100 or more and 500 or less and a molecular weight of 10000 g/mol or more and 30000 g/mol or less.

7. The method for manufacturing a dispersant according to claim 6, wherein the polyvinyl acetal-based resin satisfies a degree of polymerization degree of 100 or more and 500 or less, a molecular weight of 10000 g/mol or more and 30000 g/mol or less, and an average diameter of 400 μm or more and 5500 μm or less.

8. The method for manufacturing a dispersant according to claim 6, wherein the polyvinyl acetal-based resin includes a circular polyvinyl acetal-based resin, and the circular polyvinyl acetal-based resin satisfies a diameter of a diameter of 500 μm or more and 4000 μm or less.

9. The method for manufacturing a dispersant according to claim 6, wherein the polyvinyl acetal-based resin includes an elliptical polyvinyl acetal-based resin, and the elliptical polyvinyl acetal-based resin satisfies a long axis size of 500 μm or more and 7000 μm or less and a short axis size of 300 μm or more and 4000 μm or less.

10. The method for manufacturing a dispersant according to claim 6, wherein a content of the polyvinyl alcohol in the first solution satisfies 7 wt % or more and 13 wt % or less.

11. The method for manufacturing a dispersant according to claim 6, wherein the polyvinyl acetal-based resin is a polyvinyl butyral resin.

12. The method for manufacturing a dispersant according to claim 6, wherein the water-soluble solvent includes sodium hydroxide.

13. A method for manufacturing a dispersant, the method comprising:
preparing a first solution by dissolving polyvinyl alcohol in an organic solvent, wherein a content of the polyvinyl alcohol in the first solution satisfies 7 wt % or more and 13 wt % or less; and
condensing the polyvinyl alcohol and an aldehyde to form a polyvinyl acetal-based resin.

14. The method for manufacturing a dispersant according to claim 13, wherein the aldehyde includes butyraldehyde.

15. The method for manufacturing a dispersant according to claim 14, wherein the polyvinyl acetal-based resin is a polyvinyl butyral resin.

16. The method for manufacturing a dispersant according to claim 13, wherein the organic solvent includes N-methylpyrrolidone.

17. The method for manufacturing a dispersant according to claim 13, wherein the polyvinyl alcohol satisfies a degree of polymerization of 100 or more and 500 or less and a molecular weight of 10000 g/mol or more and 30000 g/mol or less.

18. The method for manufacturing a dispersant according to claim 13, wherein the polyvinyl acetal-based resin satisfies an average diameter of 400 μm or more and 5500 μm or less.

19. The method for manufacturing a dispersant according to claim 18, wherein the polyvinyl acetal-based resin satisfies a degree of polymerization degree of 100 or more and 500 or less.

20. The method for manufacturing a dispersant according to claim 18, wherein the polyvinyl acetal-based resin satisfies a molecular weight of 10000 g/mol or more and 30000 g/mol or less.
